(19) United States
(12) Patent Application Publication
(10) Pub. No.: US 2021/0060699 A1
(43) Pub. Date: Mar. 4, 2021

(54) LASER ABLATION FOR COATED DEVICES

(71) Applicant: HZO, Inc., Morrisville, NC (US)

(72) Inventors: John Janik, Raleigh, NC (US); Gary Owen, Layton, UT (US)

(21) Appl. No.: 17/008,267

(22) Filed: Aug. 31, 2020

Related U.S. Application Data
(60) Provisional application No. 62/894,692, filed on Aug. 31, 2019.

(51) Int. Cl. B23K 26/08; B23K 26/352

(52) U.S. Cl. CPC B23K 26/0876; B23K 26/355

(57) ABSTRACT

A laser ablation system includes a laser configured to irradiate or sublimate a portion of a thin-film coating located on an electronic device, a controller for controlling the laser, and an optical system comprising one or more optical sensors configured to detect the electronic component and a location of the portion of the thin-film coating to be irradiated or sublimated.

### RELATED APPLICATIONS

This application claims the benefit of U.S. Provisional Patent Application No. 62/894,692, filed Aug. 31, 2019, which is incorporated herein by reference in its entirety.

### BACKGROUND

Coating devices for protection from ambient conditions can present certain problems, depending on the types of devices that are coated and the coating processes that are used. For example, applying a thin coating such as parylene or plasma to an electronic device can provide protection from water, dust, and other corrosive substances or harmful conditions. However, the coating processes can be complex due to requirements that certain components on the electronic devices cannot be coated the same as other components or, in some cases, cannot be coated at all.

Some processes use manual and automated processes to mask and demask components before and after the coating is applied to the devices. While effective, known processes can be time consuming and add to the overall manufacturing costs of the devices.

### SUMMARY

The subject matter of the present application has been developed in response to the present state of the art, and in particular, in response to the problems and disadvantages associated with conventional coating removal systems that have not yet been fully solved by currently available techniques. Accordingly, the subject matter of the present application has been developed to provide embodiments of a laser ablation system that overcome at least some of the shortcomings of prior art techniques.

Disclosed herein is a laser ablation system. The system includes a laser configured to irradiate or sublimate a portion of a thin-film coating located on an electronic device, a controller for controlling the laser, and an optical system including one or more optical sensors configured to detect the electronic component and a location of the portion of the thin-film coating to be irradiated or sublimated. The plasma source includes a gas. The preceding subject matter of this paragraph characterizes example 1 of the present disclosure.

The system further includes a device carrier configured to secure and orient the electronic device. The preceding subject matter of this paragraph characterizes example 2 of the present disclosure, wherein example 2 also includes the subject matter according to example 1, above.

The optical system further includes one or more fiducials. The preceding subject matter of this paragraph characterizes example 3 of the present disclosure, wherein example 3 also includes the subject matter according to any one of examples 1-2, above.

The optical system further includes one or more fiducials. The one or more fiducials is located on the device carrier. The preceding subject matter of this paragraph characterizes example 4 of the present disclosure, wherein example 4 also includes the subject matter according to any one of examples 1-3, above.

The optical system further includes one or more fiducials, wherein the one or more fiducials is internal to the one or more optical sensors. The preceding subject matter of this paragraph characterizes example 5 of the present disclosure, wherein example 5 also includes the subject matter according to any one of examples 1-4, above.

The system further includes the electronic device including the thin-film coating, wherein the coating is parylene. The preceding subject matter of this paragraph characterizes example 6 of the present disclosure, wherein example 6 also includes the subject matter according to any one of examples 1-5, above.

The optical system is stationary, wherein the one or more optical sensors is stationary. The preceding subject matter of this paragraph characterizes example 7 of the present disclosure, wherein example 7 also includes the subject matter according to any one of examples 1-6, above.

The system further includes a control processor, wherein the control processor is configured to communicate with the controller and the optical system. The preceding subject matter of this paragraph characterizes example 8 of the present disclosure, wherein example 8 also includes the subject matter according to any one of examples 1-7, above.

The one or more optical sensors includes an automated optical inspection tool. The preceding subject matter of this paragraph characterizes example 9 of the present disclosure, wherein example 9 also includes the subject matter according to any one of examples 1-8, above.

The one or more optical sensors includes a camera. The preceding subject matter of this paragraph characterizes example 10 of the present disclosure, wherein example 10 also includes the subject matter according to any one of examples 1-9, above.

The one or more optical sensors is configured to detect and report coordinates of the electronic component to the controller. The preceding subject matter of this paragraph characterizes example 11 of the present disclosure, wherein example 11 also includes the subject matter according to any one of examples 1-10, above.

The controller is configured to control the intensity of the laser. The preceding subject matter of this paragraph characterizes example 12 of the present disclosure, wherein example 12 also includes the subject matter according to any one of examples 1-11, above.

The controller is configured to control at least one of a direction, a coherence, or a frequency of the laser. The preceding subject matter of this paragraph characterizes example 13 of the present disclosure, wherein example 13 also includes the subject matter according to any one of examples 1-12, above.

Disclosed herein is a method. The method includes providing one or more electronic devices in a laser ablation system, wherein the one or more electronic devices includes a thin-film coating, and optically sensing the one or more electronic devices with an optical system including one or more optical sensors. The method includes ablating a portion of the thin-film coating by irradiating or sublimating the portion of the thin-film coating with a laser. The preceding subject matter of this paragraph characterizes example 14 of the present disclosure

The method further includes directing nitrogen gas over the one or more electronic devices during the ablating. The preceding subject matter of this paragraph characterizes example 15 of the present disclosure, wherein example 15 also includes the subject matter according to example 14, above.

The method further includes using fiducials to mark the portion of the thin-film coating to be ablated. The preceding subject matter of this paragraph characterizes example 16 of the present disclosure, wherein example 16 also includes the subject matter according to any one of examples 14-15, above.

The method further includes utilizing between 20 percent and 80 percent power for the laser. The preceding subject matter of this paragraph characterizes example 17 of the present disclosure, wherein example 17 also includes the subject matter according to any one of examples 14-16, above.

The method further includes moving and rotating the one or more electronic devices during the ablating, wherein the one or more electronic devices is moved by a device carrier. The preceding subject matter of this paragraph characterizes example 18 of the present disclosure, wherein example 18 also includes the subject matter according to any one of examples 14-17, above.

The method includes following a part recipe that determines the scan speed of the laser and the power output of the laser during ablating. The preceding subject matter of this paragraph characterizes example 19 of the present disclosure, wherein example 19 also includes the subject matter according to any one of examples 14-18, above.

The thin-film coating includes a parylene layer and wherein the method further includes completely ablating the portion of the thin-film coating above a component of the one or more electronic devices, leaving the component exposed through the thin-film coating. The preceding subject matter of this paragraph characterizes example 20 of the present disclosure, wherein example 20 also includes the subject matter according to any one of examples 14-19, above.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 depicts a schematic diagram of a laser ablation system according to one or more embodiments.

FIG. 2 depicts a perspective view of a laser ablation system according to one or more embodiments.

FIG. 3 depicts a perspective view of a laser ablation system according to one or more embodiments.

FIG. 4 depicts a perspective view of components within a laser ablation system according to one or more embodiments.

FIG. 5 depicts another view of components within the laser ablation system shown in FIG. 4 according to one or more embodiments.

FIG. 6 depicts a perspective view of a device carrier according to one or more embodiments.

FIG. 7 depicts a perspective view of a laser ablation system according to one or more embodiments.

FIG. 8 depicts another perspective view of the laser ablation system shown in FIG. 7 according to one or more embodiments.

FIG. 9 depicts a perspective view of a laser ablation system according to one or more embodiments.

FIG. 10 depicts another perspective view of the laser ablation system shown in FIG. 9 according to one or more embodiments.

FIG. 11 depicts a plan view of one embodiment of partially ablated coating on a rectangular device component according to one or more embodiments.

FIG. 12 depicts a plan view of another embodiment of a partially ablated coating on circular device component according to one or more embodiments.

FIG. 13 depicts a perspective view of another embodiment of a partially ablated coating on a three-dimensional, complex device component according to one or more embodiments.

FIG. 14 depicts a flow chart diagram of a coating ablation method for implementation with one or more of the laser ablation systems described and shown herein.

FIG. 15 depicts a schematic diagram of a laser ablation system with a flow system according to one or more embodiments.

Throughout the description, similar reference numbers may be used to identify similar elements.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Reference to a computer readable medium may take any physical form capable of storing machine-readable instructions, at least for a time in a non-transient state, on a digital processing apparatus. A computer readable medium may be embodied by a compact disk, digital-video disk, a blu-ray disc, a magnetic tape, a Bernoulli drive, a magnetic disk, flash memory, integrated circuits, or any other digital storage and/or processing apparatus.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments facilitate improved removal of thin-film coatings on sensitive electronic devices such as circuit boards and similar devices. Due to the size and temperature constraints of such devices, as well as the typical operating conditions of most laser devices, laser ablation of thin-film coatings presents many obstacles to establishing effective and efficient processes that do not damage the coated devices.

One example of a use case for these types of ablation tasks includes consumer or industrial electronic devices that are coated with a plasma or parylene film in order to waterproof or otherwise protect the devices from adverse environmental conditions. The process of coating these devices is not simple, typically because some of the components on these types of devices cannot be coated at all, while others can be temporarily coated as long as the coating is removed prior to final assembly. For example, acoustic speakers are one type of device that might not be able to be coated at all during the coating process. As another example, electronic contact points might be coated during the coating process, but often must be uncoated as part of the final product.

To accomplish the various coating requirements, one approach relies on masking and demasking components as part of the overall coating process. With this masking/demasking approach, some device components are masked prior to coating and then demasked after the coating is applied. Demasking the components removes both the masking material and any overlying coating materials, resulting in exposure of the original component surfaces.

In contrast to a masking/demasking approach, an ablation approach might forego the use of masking materials. Consequently, when a coating is applied, it is applied directly to all the components, and subsequently, the coating is removed from certain components using a laser to ablate, melt, or otherwise remove the coating from specific component surfaces. However, many ablation techniques are not compatible with the types of components and coatings used in electronic devices, because the components are very sensitive to high temperatures and/or temperature fluctuations.

Within the context of these constraints, improved laser ablation techniques are needed to perform coating ablation processes that are compatible with sensitive electronic devices and components.

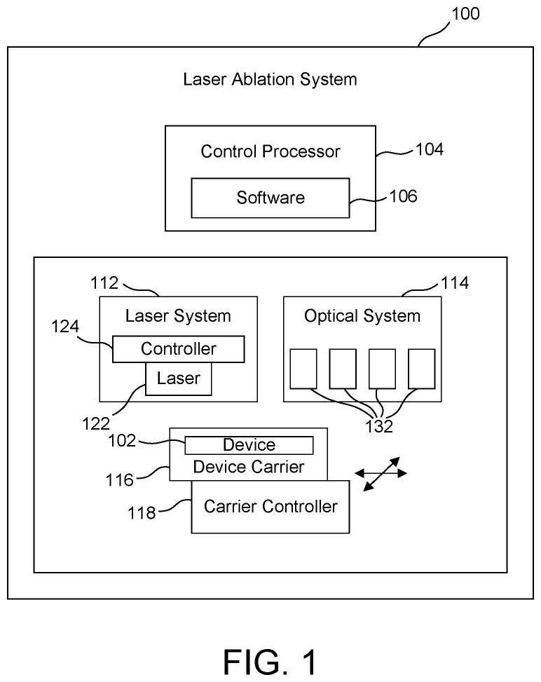

FIG. 1 depicts a schematic diagram of one embodiment of a laser ablation system 100. The illustrated laser ablation system 100 is generally configured to remove thin-film coatings from components of a device 102. The device 102 may be any type of electronic circuit board or other electronic device having component parts which are sensitive to exposure to certain types of environmental conditions, including water, moisture, dust, salt, and other potential contaminants. Although the laser ablation system 100 is shown and described with certain components and functionality, other embodiments of the laser ablation system 100 may include fewer or more components to implement less or more functionality.

The illustrated laser ablation system 100 includes a control processor 104. The control processor 104 is generally configured to control operations of the laser ablation system 100, either alone or in conjunction with various processing sub-systems integrated into other systems within the laser ablation system 100. For example, the control processor 104 might communicate electronically with a laser system 112, an optical system 114, and a carrier controller 118, as well as other any other system(s) included in various embodiments of the laser ablation system 100.

The control processor 104 also includes software 106, in some embodiments, stored on any form of computer readable medium and accessible for execution by the control processor 104. The exact form or format of the software 106 is not constrained other than to be capable of performing the functions described herein and related functions within the scope of similar devices. In particular, the software 106 may be capable of carrying out part or all of the functionality described in any methods, steps, processes, or other functional descriptions of the laser ablation system 100 and its component sub-systems.

In one embodiment, the laser system 112 includes a laser 122 and a controller 124. The laser 122 can be directed toward the device 102, or a specific component of the device 102, in order to ablate a thin-film coating applied to a surface of the device or component. The laser 122 may be any type of compatible laser that irradiates the thin-film coating and evaporates or sublimates the thin-film coating. Some examples of potentially compatible laser 122 include, but are not limited to, excimer laser, exciplex laser, ultraviolet laser, gas laser, solid-state laser, dye laser, metal-vapor laser, chemical laser, semiconductor laser, tunable laser, continuous wave laser, pulse laser, and other types of lasers.

In some embodiments, the laser system includes a controller 124. The controller 124 is configured to control various aspects of the laser, including but not limited to, the intensity of the laser 122, the directionality of the laser 122, the translational movement of the laser 122, the rotational movement of the laser 122, the coherency of the laser 122, the frequency of the laser 122, and other similar properties of the laser 122. The controller 124 may be any type of compatible controller or laser driver. Some examples of potentially compatible controllers 124 include, but are not limited to, constant current drivers, pulsing drivers, low power drivers, high power drivers, and similar controllers. In some embodiments, the controller 124 may have various subsystems or sub circuits that individually control the various properties of the laser. In some embodiments, the controller 124 electronically communicates with the control processor 104. In some embodiments, the controller 124 electronically communicates with the optical system 114 and/or the carrier controller 118. Such communication may be directly to the optical system 114 or the carrier controller 118, or via the control processor 104.

In order to assist the directionality of the laser system 112, the laser ablation system 100 may include the optical system 114. In some embodiments, the optical system 114 includes one or more optical sensors (including cameras or other optical sensors) to detect and report device coordinates to the laser system 112. In one embodiment, the optical system 114 includes four optical sensors 132. In this way, the optical sensors 132 may implement functionality to determine location and size of electronic components that need laser ablation. In an embodiment, four cameras were utilized to acquire all samples in ablation area without additional motion and to units per hour to 1500 boards/hour. Additionally, the optical sensors 132 may interface with the controller 124 and the carrier controller 118 to more precisely locate the electronic components.

In some embodiments, the optical system 114 is an automated optical inspection (AOI) tool. Automated inspection may allow for increased product flow and lower error rates. AOI allows a camera to autonomously scan the device and determine offset and location parameters for the laser system. Other types of automated optical systems are contemplated herein.

In some embodiments, the optical system 114 may include one or more fiducials or fiducial markers to help measure or locate the various components of the electronic device 102. The fiducials may be an object or physical representation that serves as a point of reference to mark the size of the electronic device 102 or its components, or measure the distance between the components of the electronic device 102. The fiducial markers may be on the electronic device 102, on the device carrier 116, or may be internal to the optical sensors 132, or other components of the laser ablation system 100. In some embodiments, a five megapixel camera is used to take a picture of the components and no fiducial markers are used.

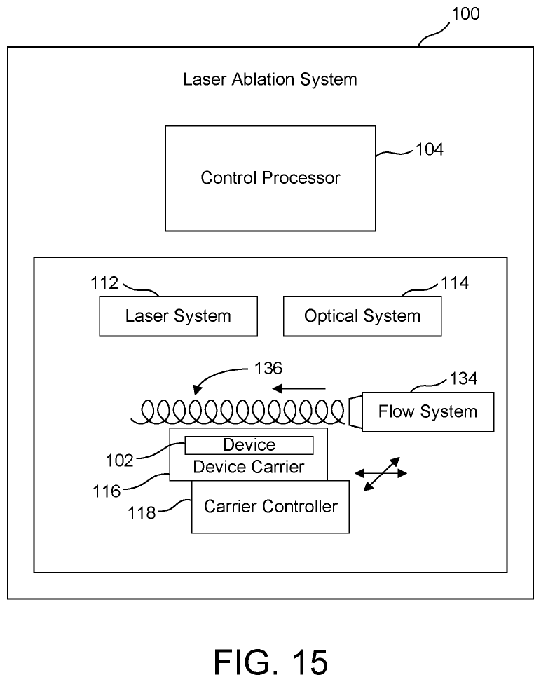

Temperature control may be important to the integrity of the electronic device 102. Temperature control in the laser ablation system 100 may be achieved through the controller 124, or a flow system (described more fully in conjunction with FIG. 15 but may be present in all other embodiments described herein), or another separate temperature control system.

In some embodiments, the laser ablation system 100 includes a device carrier 116 that secures, holds, locates, and orients the electronic device 102 to allow for proper optical reading of the electronic device 102 and proper laser ablation of the thin-film coating of the electronic device 102. The device carrier 116 may include physical features that secure the electronic device 102 in a specific location on the device carrier 116 and in a specific orientation on the device carrier 116.

In some embodiments, the laser ablation system 100 includes a carrier controller 118. The carrier controller 118 is generally configured to control movement of the device carrier 116 within the laser ablation system 100. The carrier controller 118 is configured to locate the electronic devices in a position to be optically read by the optical system 114. The carrier controller 118 is further configured to locate the electronic devices 102 in a position to be ablated by the laser system 112.

In some embodiments, the laser ablation system 100 includes a relatively stationary optical system 114 and laser system 112. In such embodiments, the device carrier 116 is rotated or translated by the carrier controller 118 to the correct positions within the laser ablation system 100. In some embodiments, the optical system 114 and the laser system 112 may also be configured to move within the laser ablation system 100. That is, the all three subsystems may be configured to move such that the optical sensors 132 are positioned to optically read the electronic devices 102 and the laser is positioned to ablate the thin-film coating of the electronic devices 102. In some embodiments, only one of the subsystems is stationary while the other two move relative to each other.

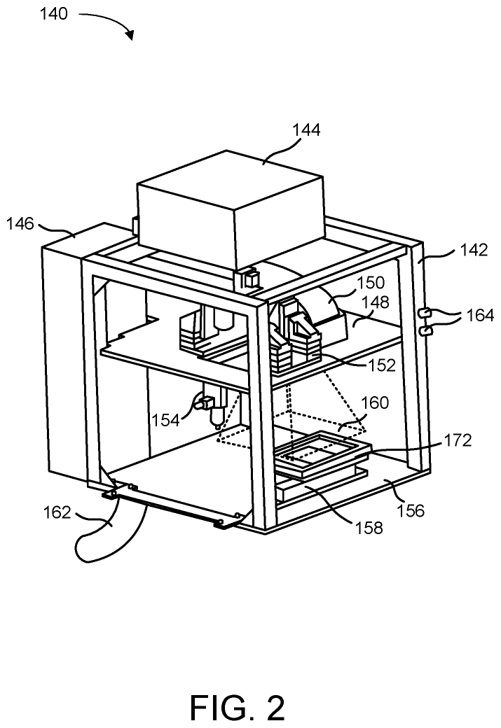

Referring now to FIG. 2, a perspective view of a laser ablation system 140 according to one or more embodiments is shown. All or some of the features described in conjunction with FIG. 1 may be incorporated into the embodiment shown in FIG. 2 and are only omitted for the sake of brevity. In addition, the features and components of shown and described in conjunction with FIG. 2 may be incorporated into the embodiment shown in FIG. 1. In addition, although the laser ablation system 140 is shown and described with certain components and functionality, other embodiments of the laser ablation system 140 may include fewer or more components to implement less or more functionality.

The laser ablation system 140 includes a frame 142 which is generally configured to house and support various subcomponents of the laser ablation system 140. The embodiment of FIG. 2 is depicted without walls to allow depiction of subcomponents internal to the frame 142. The laser ablation system 140 includes, in some embodiments, a processor 144 that is generally configured to control the subcomponents of the laser ablation system.

The laser ablation system 140 further includes a laser system 150 and optical system (including four optical sensors 152) which are positioned on an upper platform 148 within the frame 142. The laser system 150 and optical system are placed above and are generally directed towards the lower platform 156 which supports device carrier 172 and includes a carrier controller 158. The carrier controller 158 allows for the device carrier to be moved in position and within the laser range 160.

The laser ablation system 140 may further include locking mechanisms 164 that allow for the subcomponents to be secure and isolated when in use. In some embodiments, the laser ablation system 140 includes a flow system 146 which may further include a flow nozzle 154 and exhaust system 162. The flow system 146 is generally configured to direct or blow a cooling substance, such as nitrogen gas, on the electronic devices 102 during laser ablation.

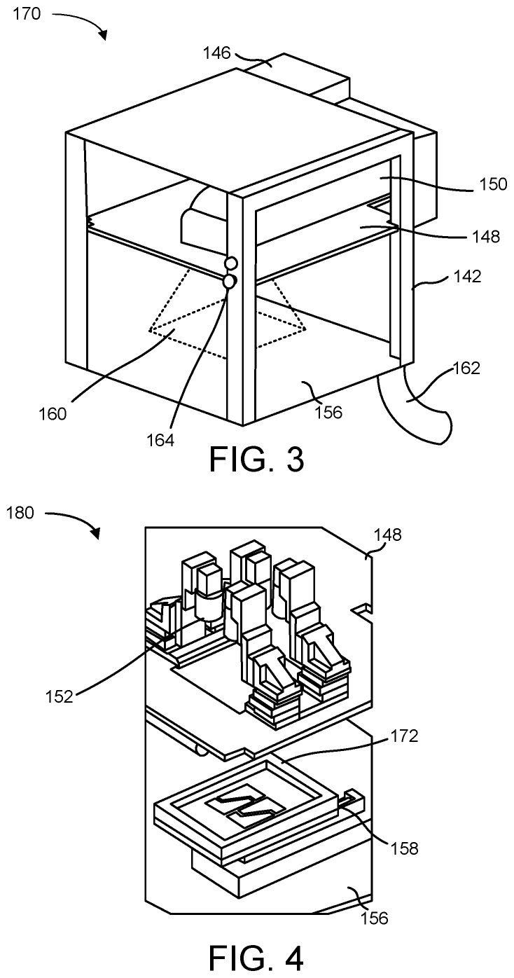

Referring now to FIG. 3, a perspective view of a laser ablation system 170 according to one or more embodiments is shown. All or some of the features described in conjunction with FIGS. 1 and 2 may be incorporated into the embodiment shown in FIG. 3 and are only omitted for the sake of brevity. In addition, the features and components of shown and described in conjunction with FIG. 3 may be incorporated into the embodiments shown in FIGS. 1 and 2. In addition, although the laser ablation system 170 is shown and described with certain components and functionality, other embodiments of the laser ablation system 170 may include fewer or more components to implement less or more functionality.

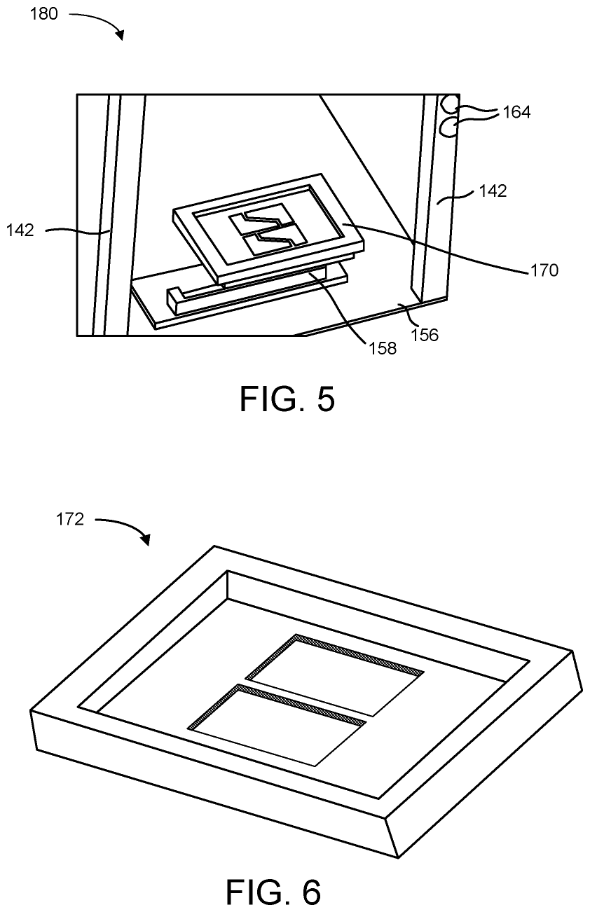

Referring now to FIG. 4, a perspective view of the optical system and the device carrier 172 is shown. FIG. 5 depicts another view of the components within the laser ablation system shown in FIG. 4 with the device carrier in a different position. FIG. 6 depicts a perspective view of the device carrier 172. The device carrier may include various physical features that allow for multiple electronic devices to be placed on the device carrier 172. The device carrier 172 is further configured to attach to and interface with the carrier controller 158.

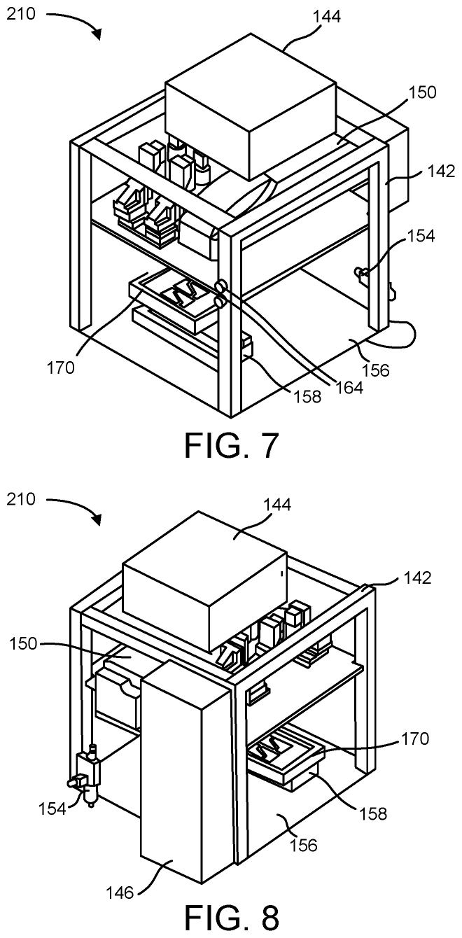

Referring now to FIGS. 7 and 8, perspective views of a laser ablation system 210 according to one or more embodiments is shown. All or some of the features described in conjunction with FIGS. 1-6 may be incorporated into the embodiments shown in FIGS. 7 and 8 and such features and description are only omitted for the sake of brevity. In addition, the features and components of shown and described in conjunction with FIGS. 7 and 8 may be incorporated into the embodiments shown in FIGS. 1-6. In addition, although the laser ablation system 210 is shown and described with certain components and functionality, other embodiments of the laser ablation system 210 may include fewer or more components to implement less or more functionality.

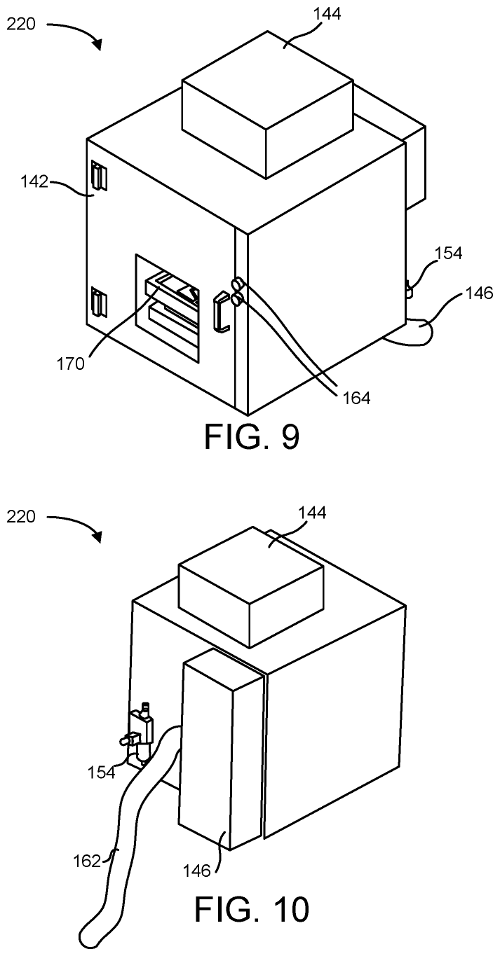

Referring now to FIGS. 9 and 10, perspective views of a laser ablation system 220 according to one or more embodiments is shown. All or some of the features described in conjunction with FIGS. 1-8 may be incorporated into the embodiments shown in FIGS. 9 and 10 and such features and description are only omitted for the sake of brevity. In addition, the features and components shown and described in conjunction with FIGS. 9 and 10 may be incorporated into the embodiments shown in FIGS. 1-8. In addition, although the laser ablation system 220 is shown and described with certain components and functionality, other embodiments of the laser ablation system 220 may include fewer or more components to implement less or more functionality.

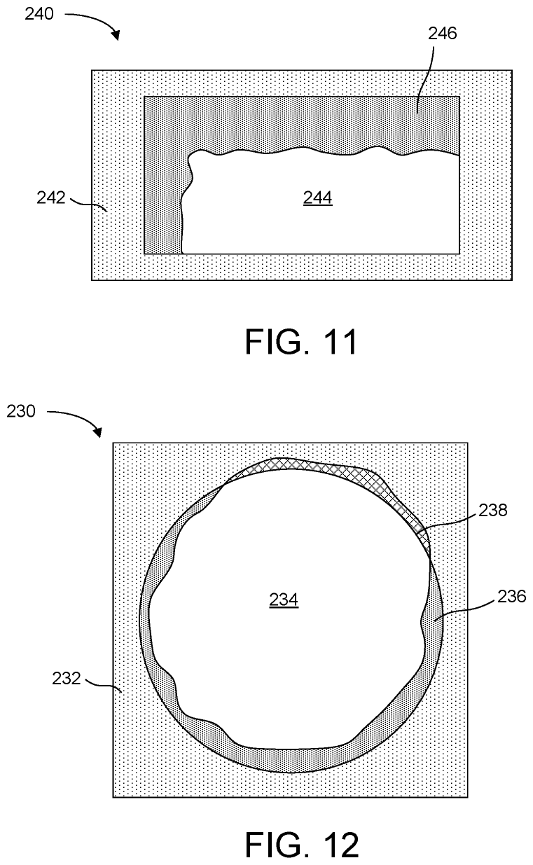

Referring now to FIG. 11, a plan view 240 of one embodiment of partially ablated coating 246 on a rectangular device component 240 is shown. The ablated surface 244 no longer has a coating 246 because it has been partially ablated. Referring now to FIG. 12, a plan view 230 of one embodiment of partially ablated coating 236 on a circular device component 232 is shown. The ablated surface 234 no longer has a coating 236 because it has been partially ablated. As shown, a portion of the coating 236 has been ablated from exposed surface 238. Depending on accuracy of the optical system and the carrier controller, the exposed surface may extend past the ablated component leaving a mismatch of what was removed and the particular location of the component. Highly accurate movement of the device carrier, along with multiple optical sensors can lead to more accuracy during the ablative process. Offset and/or rotation information can be generated by inspecting the components and may be fed back into the laser system to generate a more accurate ablation process. Software in the control process may give a user control over offset of each component to ensure the laser accurately ablates the component.

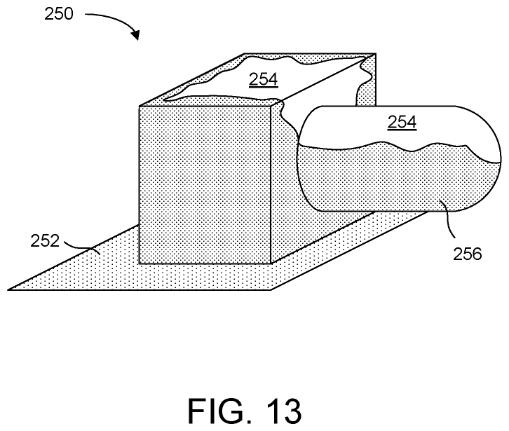

Referring now to FIG. 13, a perspective view 250 of one embodiment of a partially ablated three dimensional component 252 is shown. The ablated surface 254 no longer has a coating 256 because it has been partially ablated.

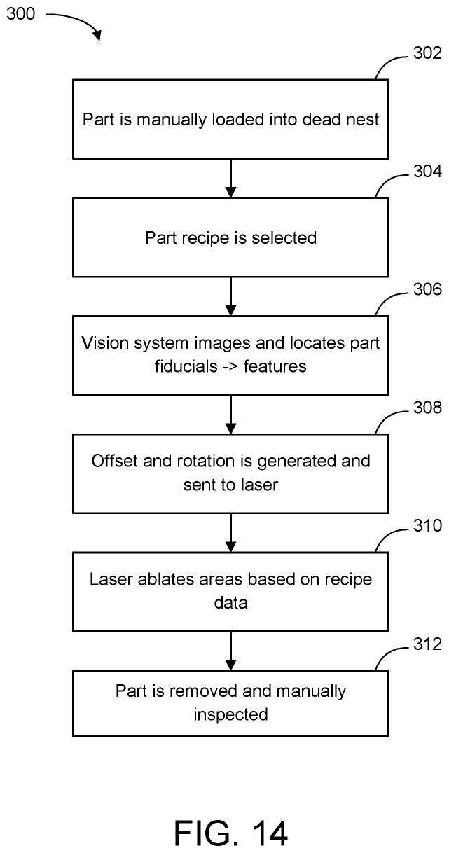

FIG. 14 depicts a flow chart diagram of a coating ablation method 300 for implementation with one or more of the laser ablation systems described and shown herein. Although the method 300 is described in conjunction with the laser ablation system of FIG. 1, embodiments of the method 300 may be implemented with other types of laser ablation systems.

At block 302, a part (or electronic device 102) is loaded into a dead nest (or device carrier 116). The part may be manually loaded in some embodiments or automatically loaded in other embodiments.

At block 304, a part recipe is selected. In this context, a part recipe may dictate how the laser ablation system operates and functions. In some embodiments, the part recipe will dictate the functionality of the laser, the movement of the device carrier, or other functions of the system in an automated manner. In some embodiments, the part recipe dictates the speed with which the laser moves relative to the device carrier, the intensity of the laser, and other features and functions.

At block 306, the optical system or vision system images the part and locates the part and fiducials and features that need to be ablated.

At block 308, offset and rotation information is generated and sent to the laser system to make adjustments and provide a more accurate ablative process for future parts. At block 310, the laser system ablates areas of the part based on the part recipe. At block 312, the part is removed and manually inspected. The method then ends.

In some embodiments, a part recipe may include the power of the laser, the scan speed of the laser, and the amount of shield gas utilized. Some embodiments include a part recipe with a scan speed of 300 mm/s with 40% power, with nitrogen. In another embodiment, a scan speed of 300 mm/s with 40% power is used, without nitrogen. In another embodiment, a scan speed of 300 mm/s with 80% power is used, with nitrogen. Various ranges of scan speeds may include between 10 mm/s and 1000 mm/s with a range of 20% to 100% power. Power and scan speed settings and nitrogen use may all be optimized to provide a more uniform ablation without charring.

Referring now to FIG. 15, a schematic diagram of another embodiment of a laser ablation system with a flow system is shown. All or some of the features described in conjunction with FIGS. 1-14 may be incorporated into the embodiment shown in FIG. 15 and are only omitted for the sake of brevity. In addition, the features and components of shown and described in conjunction with FIG. 15 may be incorporated into the embodiments shown in FIGS. 1-14. In addition, although the laser ablation system 100 is shown and described with certain components and functionality, other embodiments of the laser ablation system 100 may include fewer or more components to implement less or more functionality.

The laser ablation system 100 includes a flow system 134. The flow system 134 is generally configured to control a fluid flow near and over the electronic devices 102 during the ablative process. The fluid may be any type of gas configured to cool the component and keep the ablative process from charring the component of the electronic device 102. In some embodiments, the gas is nitrogen.

As described above, the nitrogen (or other gas) may be blown by a nozzle. In other embodiments, an air knife may be utilized in place of a nozzle. An air knife may provide a more uniform application of the shield gas. As shown in FIG. 15, the flow system may be placed adjacent to the electronic devices and may provide a flow directly over the electronic devices 102. In some embodiments, the flow system 134 creates a vortex 136 that provides a consistent flow during the ablative process. In some embodiments, the flow system 134 blows down and towards a front of the machine.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The processor may utilize computer-useable or computer-readable medium to implement functions described herein. The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A laser ablation system, the system comprising:
a laser configured to irradiate or sublimate a portion of a thin-film coating located on an electronic device;
a controller for controlling the laser; and
an optical system comprising one or more optical sensors configured to detect the electronic component and a location of the portion of the thin-film coating to be irradiated or sublimated.

2. The system of claim 1, further comprising a device carrier configured to secure and orient the electronic device.

3. The system of claim 2, wherein the optical system further comprises one or more fiducials.

4. The system of claim 2, wherein the optical system further comprises one or more fiducials, wherein the one or more fiducials is located on the device carrier.

5. The system of claim 1, wherein the optical system further comprises one or more fiducials, wherein the one or more fiducials is internal to the one or more optical sensors.

6. The system of claim 1, further comprising the electronic device comprising the thin-film coating, wherein the coating is parylene.

7. The system of claim 1, wherein the optical system is stationary, wherein the one or more optical sensors is stationary.

8. The system of claim 1, comprising a control processor, wherein the control processor is configured to communicate with the controller and the optical system.

9. The system of claim 1, wherein the one or more optical sensors comprises an automated optical inspection tool.

10. The system of claim 1, wherein the one or more optical sensors comprises a camera.

11. The system of claim 1, wherein the one or more optical sensors is configured to detect and report coordinates of the electronic component to the controller.

12. The system of claim 1, wherein the controller is configured to control the intensity of the laser.

13. The system of claim 1, wherein the controller is configured to control at least one of a direction, a coherence, or a frequency of the laser.

14. A method comprising:
providing one or more electronic devices in a laser ablation system, wherein the one or more electronic devices comprises a thin-film coating;
optically sensing the one or more electronic devices with an optical system comprising one or more optical sensors; and
ablating a portion of the thin-film coating by irradiating or sublimating the portion of the thin-film coating with a laser.

15. The method of claim 14, wherein the method further comprises directing nitrogen gas over the one or more electronic devices during the ablating.

16. The method of claim 14, wherein the method further comprises using fiducials to mark the portion of the thin-film coating to be ablated.

17. The method of claim 14, wherein the method further comprises utilizing between 20 percent and 80 percent power for the laser.

18. The method of claim 14, wherein the method further comprises moving and rotating the one or more electronic devices during the ablating, wherein the one or more electronic devices is moved by a device carrier.

19. The method of claim 14, wherein the method further comprises following a part recipe that determines the scan speed of the laser and the power output of the laser during ablating.

20. The method of claim 14, wherein the thin-film coating comprises a parylene layer and wherein the method further comprises completely ablating the portion of the thin-film coating above a component of the one or more electronic devices, leaving the component exposed through the thin-film coating.
